(19) United States
(12) Patent Application Publication
(10) Pub. No.: US 2017/0122293 A1
(43) Pub. Date: May 4, 2017

(54) Deep Water Wind Energy Capture System

(71) Applicant: Ronald COHEN, Pasadena, CA (US)

(72) Inventor: Ronald H. Cohen, Pasadena, CA (US)

(21) Appl. No.: 15/318,343

(22) PCT Filed: Jun. 10, 2015
(86) PCT No.: PCT/US15/35182

§ 371 Date: Dec. 12, 2016

Related U.S. Application Data
(60) Provisional application No. 62/010,108, filed on Jun. 10, 2014.

(51) Int. Cl. F03D 13/25; F03D 9/25; B63B 35/44; F03D 3/00; F03D 9/11; F03D 9/00; F03D 1/06

(52) U.S. Cl. CPC F03D 13/25; F03D 9/008; F03D 9/25; F03D 1/0666; F03D 3/005; F03D 9/11; B63B 35/44; B63B 2035/446; B63B 2209/20; B63B 2035/4466; B63B 2209/14

(57) ABSTRACT

The Inventive Subject Matter is a System for harvesting wind energy and natural wave energy. The harvesting can be performed on a body of water. The body of water can be an ocean or lake. The harvesting can be performed autonomously and create portable energy for ships or other purposes.

### CROSS-REFERENCE TO RELATED APPLICATION

This application claims priority to U.S. provisional application No. 62/010,108 filed Jun. 10, 2014 and US PCT application number PCT/US15/35182 filed on Jun. 10, 2015 the contents of which are hereby incorporated by reference.

### BACKGROUND

The Inventive Subject Matter is a System for harvesting wind and/or wave energy. The harvesting can be performed on a body of water. The body of water can be an ocean or lake.

Relevant Art References

The following patent publications and issued patents to Gizara et al. disclose energy capture devices including intelligent control systems; U.S. Pat. Nos. 6,956,300, 7,088,012, 7,298,056, 7,698,024, 8,260,476, 8,688,294, 8,736,243, 2013023986, 20130060402, 20110172852, 20100198429, 20090132101, 20080078316, 20070046028, 20060131890, 20050029817.

Makani wind kites: http://www.google.com/makani/ discloses wind capture devices tethered to the ground using air foils and technology for measuring wind force and direction to optimize energy capture.

Wave power buoys: http://www.oceanpowertechnologies.com discloses wave energy captured devices, tethered to the ocean floor.

These publications and all other referenced patents are incorporated herein by reference in their entirety. Furthermore, where a definition or use of a term in a reference, which is an incorporated reference here, is inconsistent or contrary to the definition of that term provided herein the definition of the term provided herein applies and the definition of that term in the reference does not apply.

### BRIEF DESCRIPTION OF THE DRAWINGS

FIG. 1 shows a preferred embodiment of the present invention with a horizontal wind turbine with 2-axis gimbal attached to a floating main body.

FIG. 2 shows another preferred embodiment of the present invention with a stabilized main body with wind turbines and wave energy capture devices.

FIG. 3 shows another preferred embodiment of the present invention with a wind capture device tethered to a main body.

### SUMMARY OF THE INVENTION

It is an object of the invention to increase the efficiency of wind energy collection devices that are mounted on floating platforms, by maintaining device orientation relative to the wind in the presence of rotational movement of such platforms.

It is another object of the invention to increase the reliability of wind energy collection devices that are mounted on floating platforms, by a) reducing torques and rotational disturbances on such devices and b) increasing the robustness of such devices to external forces.

It is another object of the invention to enable the capture of energy from wind and/or waves via a floating platform without the need to attach the platform to the floor of a body of water or without the need for deeply submerged structures.

It is another object of the invention to capture energy from the movement of water in all directions, due to waves.

It is another object of the invention to provide highly scalable energy collection that is non-polluting, renewable, and has no adverse environmental impact.

It is another object of the invention to produce fresh water from sea water without an artificial energy source.

It is another object of the invention to collect and remove floating debris from the ocean surface.

### DETAILED DESCRIPTION

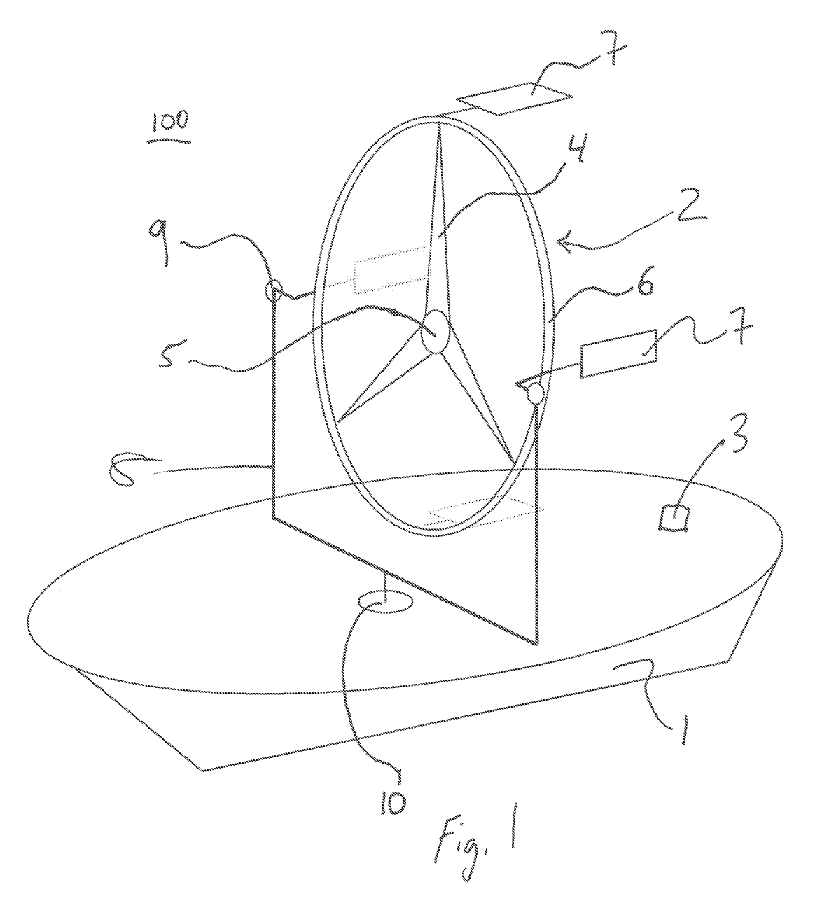

FIG. 1 discloses a preferred embodiment of an energy capture system 100. The system 100 can include a main body. The main body 1 can float on the water surface, can be partially submerged, or can be fully submerged. The main body 1 can comprise at least one: boat hull, submarine hull, or any combination of these. The main body 1 can include multiple hulls connected by structural members. The main body 1 can be fabricated from material(s) such as fiberglass, aluminum, wood, graphite composite, or steel.

The System can include a wind capture device 2. The wind capture device 2 can be a device that captures the force of wind.

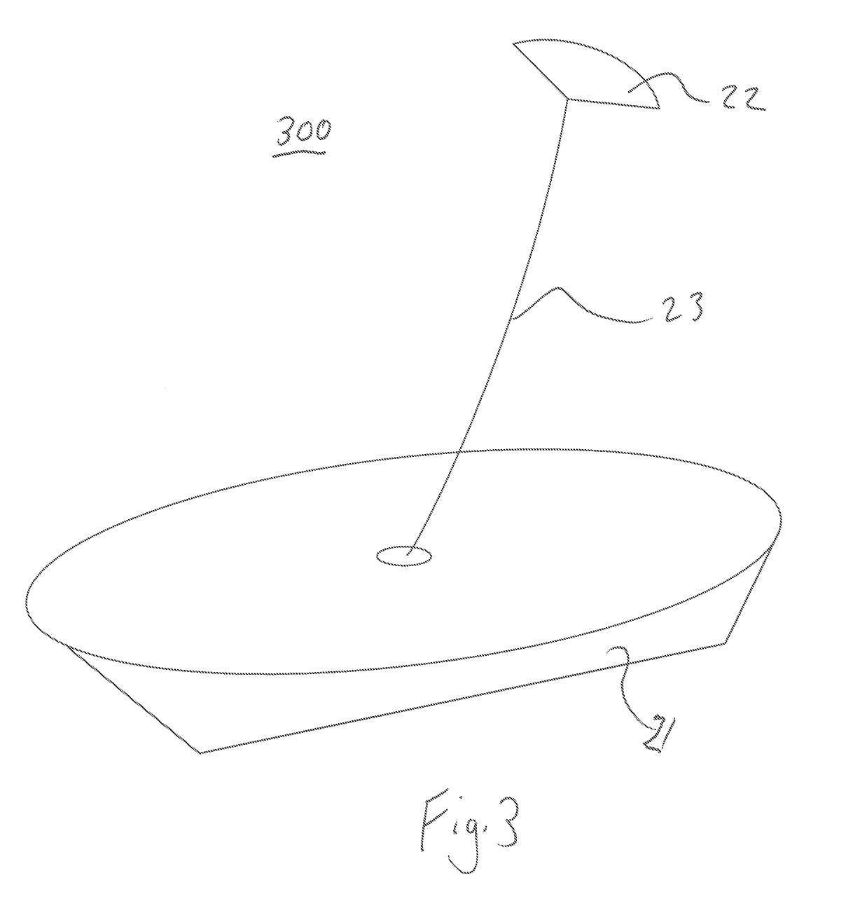

FIG. 3 discloses a preferred embodiment of an energy capture system 300. The energy capture system 300 is similar to energy capture system 100, having a main body 21. However, the wind capture device 22 is tethered to the main body 21 via a tether 23. An airborne wind capture device 22 can be a kite, a parachute, a parasail, an airfoil, a wing, or other shape. The wind capture device 22 can, from wind, create a vertical force component (lift) and a horizontal force component. The wind capture device 22 can include at least one airfoil to generate lift. The wind capture device 22 can be attached to the main body 21 via at least one tether cable 23. The airborne wind capture device 22 can be held aloft by the vertical force component. Force created by the wind capture device 22 can be transferred to the main body 21 via the at least one tether cable 23.

Referring to FIG. 1, the wind capture device 2 can be non-airborne. A non-airborne wind capture device 2 can be a sail. Such non-airborne wind capture device 2 can be attached to the main body 1, for example, via a mast. A non-airborne wind capture device 2 can transfer the force of the wind to the main body 1 via structural and/or cable attachment to the main body 1.

The wind capture device 2, 22 can be fabricated from material(s) such as Kevlar, nylon, polyester, plastic, aluminum, steel, graphite composite, fiberglass, etc.

The wind capture device 2, 22 can be inflatable.

An airborne wind capture device 22 can be inflatable, i.e. like a balloon or balloon shaped like a wing or non-inflatable, i.e. rigid kite, rigid foil, rigid wing. An airborne wind capture device 22 can be maintained aloft via any combination of any or all of: lift generated from wind, lift from a lighter-than-air gas within the wind capture device 22 or in containers attached to the wind capture device 22, lift from hot air within the wind capture device 22 or in containers attached to the wind capture device 22. Such hot air can be heated by electricity provided from the main body 21 to the wind capture device 22 via at least one cable tether. Such hot air can be heated on or in the main body 21 and pumped to the wind capture device 22 via a tube. Such tube can comprise the at least one tether cable 23 or can be attached to such tether cable 23.

The wind capture device 2 of all the embodiments disclosed herein can be controlled via an automatic control system (ACS) 3. The ACS 3 can be within the wind capture device 2, the main body 1, or distributed between them. The ACS 3 can adjust the orientation and position of the wind capture device 2 to maintain an airborne wind capture device 2 aloft, adjust the lift and horizontal force generated by the wind capture device 2 so as to maximize energy capture efficiency, adjust the trajectory of the main body 1, compensate for dynamic wind conditions, launch the wind capture device, and/or retrieve the wind capture device. 2. The ACS will have a microprocessor, software, and communications via Wi-Fi and Radio Frequency. The software is capable of calculating wind and wave vector forces for optimizing maximum efficiency while steering the main body in a safe manner.

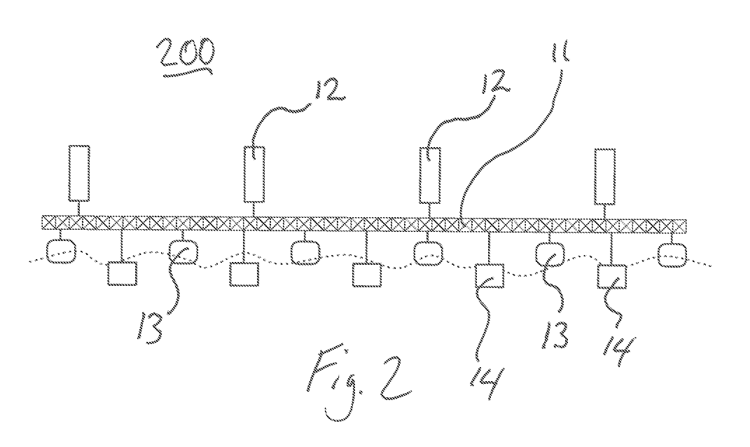

The wind force, from the wind capture device 22, can pull the main body 11 through or across the body of water via the cable tether 23. A turbine (not shown) can be attached to the wind capture device 22. A turbine, like the Makani air wing. There can be a) an airborne turbine, held aloft by and attached to the main body 21. The turbine can be wind capture device 22, b) a submerged water turbine, with the wind capture device pulling the floating platform 11 across the water (See FIG. 2), or c) a wind turbine on the deck of the platform 11 in which case the wind capture device can be used as a sail to move the platform around, FIG. 2 energy capture system 300. A turbine (not shown) can be submerged in the water. The turbine can capture the relative motion of the water and convert it into energy. The turbine can comprise at least one rotary turbine, flapping device(s), cylindrical turbine, piezoelectric generator, or any other device that converts fluid motion into energy. The turbine can drive an electrical generator, mechanical pump, or other energy conversion device. The energy thus captured can be stored in at least one energy storage device, such as an electric battery, a flywheel, a compressed fluid or gas, a chemical battery, a mechanical device storing potential energy (e.g. spring or torsion bar), etc. The energy can be used to power a Product Generator (PG). The PG can convert water and/or air into a product. The product can be ammonia, hydrogen, a hydrocarbon, or other chemical. Water used to create the product can be captured from the body of water. Nitrogen or oxygen used to create the product can be captured from ambient air. The product can accumulate in at least one storage device in or attached to the main body/platform.

The product can be offloaded from the storage device to, for example, another vessel, a ship, or a pipe. Such vessel, ship, or pipe can transport and/or consume the product. The captured energy need not necessarily be transferred as a chemical product. Such energy can be transferred in the form of a stored energy device, e.g. battery, compressed fluid/gas, mechanical energy storage device, flywheel, spring, etc.

The main body/platform can consume the product as a fuel, for use in moving the system and/or powering devices.

In an embodiment in which the main body 1 is partially or completely submerged, the system can be more robust with respect to sea state than a fully surface-based system. In deep water, the extent to which the main body 1 moves with wave motion reduces with submersion depth. Wave-induced motion of the main body 1 can induce movement of, and complicate control of, the wind capture device 2. Furthermore, wave-induced motion of the main body 1 can cause mechanical stress and other complications on or in the main body 1. Thus, a fully or partially submerged main body 1 can potentially operate with higher efficiency and reliability than a non-submerged main body 1. The depth of a submerged main body 1 can be adjustable. A submerged main body 1 can include a snorkel, reaching above the water surface, to intake ambient air.

The Turbine can be not included in or not attached to a hydrofoil.

An alternative preferred embodiment is wherein wind energy can be captured directly via a wind turbine. A wind turbine can comprise at least one of the turbine types described in Embodiment 100, 200, 300, and/or can be a vertical axis wind turbine, and/or can be a horizontal axis wind turbine. A wind turbine can be attached to a main body/platform. A wind turbine can be exposed to the wind. The relative motion of the wind impinging upon a wind turbine can be used to capture energy. A wind turbine can drive an energy conversion device that captures and stores energy as in Embodiment 100, 200, 300. The wind turbine can be fabricated from material(s) such as fiberglass, carbon fiber composite, graphite composite, wood, plastic, and metal.

At least one sail can be attached to a main body/platform. Such sail can be adjusted to guide the main body/platform on a desired trajectory. The main body/platform can have at least one submerged keel. Such keel can be fabricated from, for example, steel, fiberglass, wood, plastic, or graphite composite.

It should be understood that the main body 1, 21, and plat form 11 serve the same anchoring purpose through the remainder of this detailed description, and reference is intended to be inclusive for each of the Embodiments 100, 200, 300. The keel can be rotatable with respect to the main body, or fixed with respect to the main body. The relative angle between the keel and the relative wind can be adjusted to control the motion of the main body with respect to the water. If the keel is perpendicular to the relative wind vector then the keel prevents significant motion of the system in the direction of the wind, due to the drag force of water on the side of the keel.

The keel can be rotated to produce motion in a desired direction. Such motion can be the result of the vector sum of the wind force(s) impinging on the wind turbine, sail, and/or main body, the water force on the keel, which is primarily normal (perpendicular) to the keel, and the water drag on the main body 1 and keel. Such motion is also affected by water currents.

A wind turbine (as defined above) can be attached to a gimbal mechanism 8 such that the wind turbine can rotate relative to the main body 1. Such rotation can be in two axes. Such a gimbal mechanism 8 enables the main body 1 to rotate in any or all of the three perpendicular axes (e.g. roll, pitch, yaw) while the wind turbine maintains a fixed orientation. Thus, the main body 1 can rotate due to the action of waves, wind, or other disturbances while the wind capture device 2 maintains a fixed orientation. This rotation isolation can maintain the wind capture device 2 in an orientation that is optimal, or near-optimal, for capturing wind energy (i.e. parallel or close to parallel to the relative wind vector), despite rotation of the main body.

Rotational isolation of a gimbaled wind capture device 2 can reduce mechanical stress on the wind capture device 2 and/or other components by reducing torques and stress on the turbine. For example, a wind capture device 2 comprising a horizontal axis wind turbine can incur stresses on the turbine blades, mechanisms, gears, and/or energy capture device (e.g. generator), if the axis of rotation moves, due to, for example, rotation of the main body 1 due to wave motion.

Horizontal axis wind turbines typically have turbine airfoil blades 4 attached to a center hub 5. In the inventive subject matter such blades 4 can be attached to an outer structure 6 at the tip of the blades 4, or to both an outer structure 6 and a center hub 5. The outer structure 6 can be a ring or band circumferentially enclosing the blades 4. The outer structure 6 can be, or can be attached to, a wind lens. A wind lens modifies airflow by creating a low pressure region downwind of the turbine, which in turn increases the speed of the wind through the turbine.

Attaching the blades 4 to the outer structure 6 rather than the center hub 5 can reduce mechanical stress on the blades 4. While the above-mentioned gimbals can reduce mechanical stress arising from rotation of the main body, stress due to translation can remain problematic. Stress due to translation can be mitigated by attaching the blades 4 to an outer structure 6. The blades 4 can be attached at the tip, anywhere between the rotational axis and tip, or at multiple places between the rotational axes and the tip. There can be more than one outer structure 6. Such outer structures 6 can be of different sizes.

Blades 4 can have their innermost points attached to a hub 5 at or near the axis of rotation.

An outer structure 6 can include a rolling-element bearing (e.g. a roller bearing). An outer structure 6 can capture rotational energy and/or torque from a wind turbine and transmit it to an energy storage device (e.g. an electrical generator, a pump, a compressor, or a mechanical energy storage device) or to a propeller or other propulsive device. The outer structure 6 can capture and transfer energy via a gear coupling that is driven by the outer race of the roller bearing and that drives an electrical generator, hydraulic compressor, or other such energy capture device. The outer structure 6 can be fabricated from material(s) such as steel, aluminum, fiberglass, carbon composite, graphite composite, plastic, or wood.

A wind turbine can be maintained in a favorable orientation with respect to the relative wind by a) “weathervaning” or “weathercocking” action of the wind turbine induced by the aerodynamic center of pressure of the wind turbine being downwind of at least one gimbal axis of rotation of the wind turbine and/or b) rotating the wind turbine around at least one gimbal axis of rotation of the wind turbine. Weather-vaning action can be induced and/or enhanced and/or by adding fins/vanes 7, which can move the center of pressure away from the center(s) of rotation. A wind turbine's rotational position can be actively controlled by sensing rotation (e.g. via measuring angular position and/or acceleration via inertial measurement unit, gyroscope, accelerometer, gimbal angular position sensor, etc.) and applying rotational torques via devices such as servo motors, gas or hydraulic actuators, etc. Weather-vaning action can be induced via the force of wind on least one fin or vane 7. A wind turbine's rotational position can be controlled via a combination of an active control system 3 and passive weathervaning.

A spinning wind turbine (e.g. horizontal axis wind turbine or vertical axis wind turbine) that uses the gimbal system described above can be robust with respect to rotational perturbations (such as rotation of the main body) via gyroscopic stablization, i.e. since torque is required to move the angular momentum vector of the spinning turbine, the spin axis tends to remain fixed in the absence of significant torque disturbances.

The gimbal mechanism 8 can include 2 sets of rotational bearings. Each bearing set 9,10 can comprise at least 1 rotational bearing. The 2 bearing sets can have rotational axes that are perpendicular to each other. One bearing set can rotate in pitch 9 (up and down) and another other bearing set can rotate in yaw 10 (left and right). The bearing rotational axes can intersect, or the bearing rotational axes can be non-intersecting. In the latter (non-intersecting) case, one axis of rotation can be upwind and the other downwind.

Similarly to the rotational isolation from main body movement described above, translational isolation from main body movement can be provided by active counter-movement. Motion and/or acceleration of the main body and/or wind turbine can be measured by accelerometer, inertial measurement unit, gyroscope, or the like. Such measurement(s) can be used in a control system. The control system can use one more effectors, such as hydraulic cylinders, to counteract and/or control translational acceleration and/or movement of the wind turbine.

Gimbal herein means a gimbal mechanism 8 that allows rotation about multiple axes. The gimbal mechanism 8 can include gimbal stops to limit excessive rotation. Full gimbals generally include three rotational axes, but if used with a rotary wind turbine, a two axis gimbal can be used, since the turbine rotates about one axis.

A wind turbine typically can be from 1 to 30 meters in the extent of its blades, and typically can be approximately 10 meters in blade extent.

General

The main body can be guided across a body of water by software in at least one computer, part of the ACS 3. The software and/or computer can adjust or maximize the efficiency of the overall system based on actual and/or predicted factors such as winds, water currents, rendezvous points for product off-loading or maintenance, travel times, collection vessel capacity, transfer vessel capacity, market conditions, energy prices, fuel prices, commodity prices, interest rates, maintenance facility availability, operating and maintenance costs, labor costs, etc.

For example, it may be desired to guide the system into areas with winds that are high but not excessive. Optimization criteria can include energy captured, time or fuel used to reach offload points, time or fuel used to move into favorable wind and current capture conditions, etc.

The main body can be attached or unattached to the floor of a body of water. The main body can be unanchored or untethered to the floor of an ocean, lake, or other body of water in which the system operates.

A fleet of vessels as described here can collect large amounts of stored energy, e.g. in the form of a chemical. This stored energy can be transported to and used on land, e.g., as a fuel, or to other vessels.

Platform Stabilized Via Large Footprint

FIG. 2 shows an alternative preferred embodiment with a main body platform 11 with wind turbines 12 attached above. The main body platform 11 further is supported in water via floats 13. Additionally, the main body platform 11 can have wave energy capture devices 14 attached below.

In one embodiment, the main body platform 11 includes multiple floats 13. Such floats 13 can be boat hulls. The floats 13 can be connected via a rigid structure, such that a) the floats 13 are motionless with respect to each other and b) the maximum dimensions of the main body platform 11 are large compared to the water wavelengths in the body of water. As the maximum extent of the main body platform 11 increases, in the horizontal plane parallel to the water surface, the movement of the main body platform 11, in both translation and rotation, due to wave action, reduces. Thus, a main body platform 11 comprising, for example, a horizontal set of floats 13 connected by a rigid structure and extending in the horizontal plane over a distance much larger than the typical wavelength would move only slightly due to wave action. In general, the larger the horizontal extent of the main body platform 11, the greater the motion stability and the larger the waves that such main body platform 11 can resist, in terms of stability. In this embodiment the main body platform 11 can included a truss, lattice, or other such open structure comprising multiple connecting elements to which other components, e.g. floats, containers for machinery, and tanks, are attached. Such structure can be fabricated from material(s) such as steel, aluminum, wood, fiberglass, plastic, carbon composite, wood, etc.

Wind Energy Capture Via Large Stabilized Platform

Such a stabilized main body platform 11 can be serve as a base for at least one wind turbine 12. Because the main body platform 11 is stabilized with respect to wave action, a wind turbine 12 mounted on such main body platform 11 in turn suffers minimal movement due to waves; such a wind turbine 12 is not subject to the excessive forces or torques that would result from wave action on a non-stable platform. Therefore, a wind turbine 12 on such a stabilized main body platform 11 can be simpler, lower cost, and more reliable than a wind turbine on a non-stabilized platform because it is subject to less movement, force, and stress. Furthermore, a wind turbine 12 on such stabilized main body platform 11 can be more efficient than one on a non-stabilized platform because its orientation relative to the wind is maintained more optimally relative to the wind, since the platform moves less.

Wave Energy Capture Via Large Stabilized Platform

Such a stabilized main body platform 11 can serve as a base for collection of water wave energy. Since the main body platform 11 moves minimally with respect to the overall body of water, each wave produces water motion with respect to the main body platform 11. The motion of one point in the water is generally circular/orbital with respect to the main body platform 11, in a vertical plane parallel to the direction of wave motion. Thus, a submerged object fixed to the platform will observe a relative flow of water, with the relative velocity vector of the flow rotating in the vertical plane parallel to the direction of wave travel. The wave energy can be captured by at least one wave energy capture device attached to the platform. Different types of wave energy capture devices 14 can be attached to the platform. Such wave energy capture device can be, for example:
1) A submerged flapping device that oscillates as water flows past and that captures energy from the oscillating flapping motion, and that can rotate such that it remains aligned with the flow of water as such flow changes direction.
2) A submerged high-drag oscillating device comprising an object that resists movement relative to the surrounding water, such as at least one flat rigid sheets, and fixed to move along a linear track. Such device can be moved, relative to the main body platform 11, by the flow of water from wave action, in a linear oscillating fashion. There can be several types of such devices:
   a) A high-drag horizontal oscillator, that oscillates horizontally along a track that is approximately aligned with the direction of wave travel, and is pushed back and forth on such track by wave motion, and wherein the track is rotated via a mechanism that keeps it aligned with the direction of wave motion.
   b) A self-aligning high-drag horizontal oscillator, similar to the high-drag horizontal oscillator above except that the track rotates freely and is self-aligning with the direction of wave motion. In this case the force of water impingement on the high-drag device causes a torque that rotates the track to be in alignment with the wave travel direction.
   c) A high-drag vertical oscillator, similar to the horizontal oscillators except that the device is pushed along a vertical track by wave action.
3) A flotation-based vertical oscillator. This can use a float, floating on the water surface and moving vertically due to vertical motion of the water surface due to waves. This device can move linearly along a track that is attached to the platform or can pivot around a horizontal hinge that is attached to the platform, in which case the hinge axis can lie in the horizontal platform plane and the oscillator “flaps” vertically with the vertical motion of water due to wave. This device can directly drive a generator or can drive a hydraulic or gas piston that in turn drives a generator.
4) A submerged turbine or turbines.
   a) The turbine can be in a fixed orientation relative to the platform.
      i) Such fixed orientation turbine can be of the type that has its axis of rotation aligned with the fluid flow. Multiple such turbines, in different orientations, can be used to capture energy from fluid flow in any direction. For example, 3 such turbines, with orthogonal axes of rotation, can capture fluid flow energy from any direction. A fluid flow enhancement device, such as a venturi tube or cowl, can be attached to the turbine to increase the speed of water flow through the turbine.
      ii) Such fixed orientation turbine can be of the type that has its axis of rotation perpendicular to the fluid flow (e.g. similar in concept to a vertical axis wind turbine or rooftop turbine air ventilator). Multiple such turbines, in different orientations, can be used to capture energy from fluid flow in any direction. For example, 3 such turbines, with orthogonal axes of rotation, can capture fluid flow energy from any direction.
   b) The turbine can be gimbaled in at least one axis and can weathervane so that it remains aligned with the relative flow of water, as the flow direction changes due to wave motion. Weathervaning can be accomplished by having the device's fluid dynamic center of pressure downstream from its center of gimbal rotation.

Wave Energy Capture Via Non-Stabilized Platform

Wave energy can be captured by collecting the motion of surface water relative to sub-surface water, rather than using the relative motion between water and the platform. Examples of devices using this principle are those from Ocean Power Technologies (http://www.oceanpowertechnologies.com). Such devices are conventionally tethered to the ocean floor. In an embodiment of the inventive subject matter, devices that collect energy from vertical and/or horizontal movement of surface (and/or near-surface) water relative to sub-surface water, can be attached to the main body platform. In this case the main body platform need not be large, stabilization is not needed, and the platform and devices can be untethered (unattached to the floor of the body of water).

Attributes of an Energy Capture Platform

The floating stabilized main body platform 11, used for capturing wind and/or wave energy, can drift freely. Such a main body platform 11 can be moved via at least one motor. Such motor can be electric or combustion-based. Such combustion-based motor can use, as a fuel, a chemical product produced by the platform from energy captured from wind and/or waves. Such a main body platform 11 can be moved via at least one sail. Such a main body platform 11 can be moved by being towed or pushed by another vessel.

Such a main body platform 11 can have multiple types of energy capture devices attached to it, e.g. at least one wind turbine for capturing wind energy and/or at least one device for capturing wave energy.

Such a main body platform 11 typically can be approximately 300 meters in horizontal extent, although such extent can typically range from 10 to 1000 meters. Such a main body platform 11 can be rectangular, in which case it can be approximately 300 meters in each of horizontal length and width. Larger horizontal dimensions generally provide greater stability, energy capture capability (due to being able to mount more capture devices), and economies of scale. Such a main body platform 11 can move or be moved to optimize at least one of:
1) Wind energy that can be captured, i.e. movement to areas of high winds,
2) Wave energy that can be captured, i.e. movement to areas of large waves,
3) Avoidance of land masses, other objects, or other such platforms,
4) Travel distance or fuel consumption of a vessel that will rendezvous with the main body platform 11, such as tanker that will offload a product from the main body platform 11, or maintenance ship.

The calculations to optimize the above variables can be performed in a computer on the main body platform 11 or in a remote computer. A remote computer can optimize the overall efficiency of at least one such main body platform 11 and at least one vessel that will rendezvous with such main body platform 11. Efficiency can be based on time, travel distance, fuel consumption, cost, amount of product retrieved, receiving port capacity, customer demand, or other factors.

Such a main body platform 11 can include:
1) A positioning or navigation system, such as GPS or LORAN,
2) A communication system, such as radio,
3) A system for detecting nearby objects, such radar, sonar, laser, or a video camera, with associated software and computer processing capability.
4) A computer with software that plans movement based on a) optimization of criteria such as those listed above or b) guidance instructions received from a remote computer.

Such a main body platform 11 can include at least one system to protect the platform or its contents against damage or theft. Such system can include mechanisms to release or spray a product produced by the main body platform 11, or self-scuttle. Such a main body platform 11 can send information to a remote control center. Such control center can command defensive actions by the main body platform 11, or defensive actions can be commanded by software and a computer onboard the main body platform 11. The main body platform can include at least one mechanical and/or electronic lock that prevents unauthorized access to the platform and/or its contents.

Energy Storage and Transport

Energy captured from wind or waves, via wind turbine, water turbine, oscillating device, or other mechanism, can drive an electrical generator, mechanical pump, or other energy conversion device. The energy thus captured can be stored in at least one energy storage device, such as an electric battery, flywheel, compressed fluid or gas, or mechanical device storing potential energy (e.g. spring or torsion bar).

Examples of electric battery types that can be used to store energy include: lead-acid, lithium-ion, nickel-iron, salt water, nickel metal hydride, and ferrate salt (super iron).

Electrical energy stored in at least one battery can be transported by, for example, a) transferring electrical energy, via electric conductor, from at least one battery in the platform or main body to at least one battery on a transport vessel, or b) physically transferring at least one battery from the platform or main body to a transport vessel. Such transport vessel can travel to a destination (e.g. a port) wherein the electrical energy in the battery(s) can then be offloaded by, for example, a) transferring electrical energy, via electric conductor, from at least one battery in the transport vessel to a device that receives or stores electrical energy, e.g. at least one other battery, flywheel, power grid, etc. or b) physically transferring at least one battery from the vessel to a receiving station which can in turn connect the battery(s) to an electric power grid, energy storage device, or other energy consumer, or can transport the battery(s) elsewhere.

Captured energy can be used to produce a chemical product, which can then be offloaded to a transport vessel for transport elsewhere (e.g. a port) for use. An example of such product is ammonia, which can be produced via solid-state ammonia synthesis, which can be obtained from the water upon which the platform or main body floats, nitrogen, which can be obtained from air, and electricity. Another example is hydrogen, which can be produced from water and electricity. Another example is a hydrocarbon fuel, which be produced from electricity, carbon dioxide extracted from water, and hydrogen extracted from water.

If the platform or main body is close enough to a land mass, captured energy can be transported to the land mass via electric conductor, or a chemical product can be transported to the land mass via a pipe or tube.

The main body or platform can consume the product as a fuel, for use in moving the system and/or powering devices.

Captured energy can be transferred via microwave, laser, or other electromagnetic radiative transmission (herein “beaming”). Such beaming can be performed directly to a receiving station on land, if the generation platform is close enough to land. If the generation platform is too far from the receiving station to enable direct transmission then relays can be used. Such relays can receive and retransmit the energy to another relay or to the ultimate destination receiving station. Such relays can float on a body of water, e.g. an ocean. Such relays can be affixed to buoys, boats, or ships. Such relays be mounted on or in spacecraft, in which case energy is beamed from the generating platform/main body to such spacecraft and is then relayed to another relay or to the ultimate destination receiving station.

Desalinization

Energy, captured as described above, can be used to desalinate water. This can be done via reverse osmosis, electrolysis, distillation, low temperature desalinization, thermionic desalinization, electrodialysis, or other process. Desalinization can be performed using a) electricity, derived from wind and/or wave energy, b) air or water pressure, derived from wind and/or wave energy, or a combination of both. Desalinization can be performed on a platform that is a) floating on a body of water and not tethered to the floor of the body of water, b) floating on a body of water and tethered to the floor of the body of water, or c) rigidly attached to the floor of the body of water. The desalinization can take place in a module attached to a main body 1, 21 or platform 11.

Garbage Collection

In one embodiment a garbage collection unit can be attached to the main body or the main body platform. The garbage collection unit can include a net, mesh, sieve, strainer or similar device (the “filter”) that captures objects floating on the water surface. The garbage collection unit can passively filter garbage from the water based on the movement, due to waves and/or movement of the main body or main body platform, of water through the filter. The garbage collection unit can actively filter garbage from the water by pumping, pushing, or otherwise moving water through the filter. The garbage collection unit can include a mechanism (e.g. rotary) that sweeps a filter across the water surface. The garbage collection unit can include an arm or scraping device the pushes collected garbage from the filter into a receptacle. Collected garbage can be offloaded to another vessel for transport to land.

Additional modifications and improvements of the present invention may also be apparent to those skilled in the art. Thus, the particular combination of parts described and illustrated herein is intended to represent only one embodiment of the invention, and is not intended to serve as a limitation of alternative devices within the spirit and scope of the invention.

I claim:

1. A horizontal axis wind turbine with axis of rotation parallel to a wind, comprising at least one turbine blade and a circumferential ring wherein the at least one blade is attached at a blade tip to the circumferential ring.

2. The horizontal axis wind turbine of claim 1 wherein, the turbine is mounted on a floating platform.

3. The horizontal axis wind turbine of claim 1 wherein, the circumferential ring being the inner race of a roller bearing.

4. The horizontal axis wind turbine of claim 3 wherein, the roller bearing is mounted in a 2-axis gimbal.

5. A vertical axis wind turbine with a turbine axis is attached directly to a gimbal cage at both ends.

6. The vertical axis wind turbine of claim 5 wherein, the turbine is mounted on a floating platform.

7. The vertical axis wind turbine of claim 5 wherein, the circumferential ring being the inner race of a roller bearing.

8. The vertical axis wind turbine of claim 7 wherein, the roller bearing is mounted in a 2-axis gimbal.

9. A system that floats on a body of water comprising, a stable platform that is stabilized by the horizontal dimensions being larger than one wavelength and not anchored, at least one wind turbine for converting wind into electrical energy.

10. The system of claim 9, wherein the electrical energy is created from air and water and stored.

11. A system that floats on a body of water comprising, a stable platform that is stabilized by the horizontal dimensions being larger than one wavelength and not anchored, at least one wave turbine for converting wave energy into electrical energy.

12. The system of claim 11, wherein the electrical energy is created and stored from air and water.

13. A system on the surface of a body of water that captures energy from wind and/or waves and uses the captured energy to desalinate water from the body of water.

14. The system of claim 13 wherein the system is tethered to the floor of the body of water.

15. The system of claim 13 wherein the system is not tethered to the floor of the body of water.

16. The system of claim 13 wherein the system is rigidly attached to the floor of the body of water.

17. The system of claim 11 wherein the system has a garbage collection armature.

18. The system of claim 11 wherein the system has a desalinization device.
